(19) United States
(12) Patent Application Publication
(10) Pub. No.: US 2004/0200931 A1
(43) Pub. Date: Oct. 14, 2004

(54) Aircraft air bag unwanted intrusion preventative deployment system

(76) Inventor: William C. Sanford, Mukilteo, WA (US)

Correspondence Address: Jeffrey J. Chapp, Artz & Artz, P.C., Suite 250, 28333 Telegraph Road, Southfield, MI, 48034, US

(21) Appl. No.: 10/374,431

(22) Filed: Feb. 25, 2003

(51) Int. Cl. B64D 11/00

(52) U.S. Cl. 244/118.5

(57) ABSTRACT

An air bag intrusion preventative deployment system (12) for delaying and preventing unwanted intrusions within an aircraft (10) includes an activation switch (14), a generator (16), and an air bag (18). The generator (16) is coupled to the activation switch (14) and to the air bag (18). The activation switch (14) when in an activated state triggers the generator (16) to deploy the air bag (18) to delay and prevent an unwanted intrusion.

### TECHNICAL FIELD

The present invention relates generally to aeronautical vehicle flight safety and security, and more particularly, to a system for delaying and preventing unwanted intrusions within an aircraft.

### BACKGROUND OF THE INVENTION

Due to a recent and increasing concern over aircraft intrusions, various precautionary intrusion and security devices, measures, and techniques are under consideration and development for prevention thereof. An aircraft intrusion typically refers to an undesired or unwarranted act of entering a flight compartment, during flight, without authorized clearance, potentially resulting in hijacking of the aircraft, damage to the aircraft, and/or injury to flight crew, such a pilot or flight attendant, or other aircraft occupant or passenger. Although, the above-stated situation is commonly referred to and is included within the meaning of the term “aircraft intrusion”, other forms of undesired intrusion within an aircraft are also included, such as entering any restricted area.

It may be possible for a single person or group of persons to obtain control over a passenger aircraft in flight by gaining access to a cockpit or flight compartment. Often a flight compartment is separated from a passenger compartment by a breachable flight deck entry door. Access to the flight compartment is not always strictly controlled. Luring or forcing a pilot into the passenger compartment can result in takeover of the aircraft.

Proposals for reinforcing the flight compartment door, as to prevent unwanted intrusion, do not prevent an assailant from gaining access to the flight compartment when the door is voluntarily opened. A flight crewmember may open the door for various reasons including investigation of disturbances, utilization of facilities, interaction with other crewmembers, or other reasons known in the art.

Although, there have been many responses to changes in procedures and design of aircraft interfaces to address flight deck intrusion, additional precautions and safety measures are desired. Devices under consideration have ranged from strengthening of the flight deck entry door to specialized training for the flight crew.

Current approaches to solving the unwanted intrusion problem contribute to safety of flight, and many of which focus on delaying and preventing access to a flight compartment. Although, further delay and prevention of access to a flight compartment is desirable delay and prevention of access to other areas of the aircraft are also desirable. For example, it may also be desirable to prevent access to a galley area, a baggage compartment, to exit doors, to an electronic control area, or to other restricted access areas of the aircraft.

It is therefore desirable to provide a system for further delaying or preventing unwanted intrusion within restricted access areas of an aircraft and provide improved aircraft safety and security. It is also desirable that the system occupy minimal interior aircraft space and be light in weight.

### SUMMARY OF THE INVENTION

The present invention provides a system for delaying and preventing unwanted intrusions within an aircraft. An air bag intrusion preventative deployment system for delaying and preventing unwanted intrusions within an aircraft is provided. The system includes an activation switch, a generator, and an air bag. The generator is coupled to the activation switch and to the air bag. The activation switch when in an activated state triggers the generator to deploy the air bag to delay and prevent an unwanted intrusion.

One of several advantages of the present invention is that it provides an air bag deployment system that delays ability of an unwanted or unauthorized intruder from disrupting normal operations with an aircraft. In so doing, the present invention provides increased aircraft, flight crew, and passenger safety, and further provides increased security.

Another advantage of the present invention is that it provides a system and method of restraining an impending assailant that accounts for inherent space and weight limitations of an aircraft by occupying minimal space and being light in weight.

Furthermore, the present invention is versatile in that it may be utilized in various areas of an aircraft to prevent access to crewmembers, passengers, and restricted areas. The present invention provides a period of time in which crewmembers may perform other preventative tasks to further prevent unwanted intrusion and potential harm to the aircraft or injury to flight crew and passengers.

The present invention itself, together with further objects and attendant advantages, will be best understood by reference to the following detailed description, taken in conjunction with the accompanying drawing.

### BRIEF DESCRIPTION OF THE DRAWINGS

FIG. 1 is a perspective view of an aircraft utilizing an air bag intrusion preventative deployment system for delaying and preventing unwanted intrusions in accordance with an embodiment of the present invention;

FIG. 2 is a cross-sectional top view of a fore portion of an aircraft incorporating use of an air bag intrusion preventative deployment system in accordance with another embodiment of the present invention; and

FIG. 3 is a method of delaying and preventing unwanted intrusions within an aircraft in accordance with an embodiment of the present invention.

### DETAILED DESCRIPTION OF THE PREFERRED EMBODIMENT

In each of the following figures, the same reference numerals are used to refer to the same components. While the present invention is described with respect to a system and method of delaying and preventing unwanted intrusions within an aircraft, the present invention may be adapted for various applications including ground-based vehicles, aeronautical vehicles, watercraft, and other applications known in the art that where prevention of unwanted intrusions is desired.

In the following description, various operating parameters and components are described for one constructed embodiment. These specific parameters and components are included as examples and are not meant to be limiting.

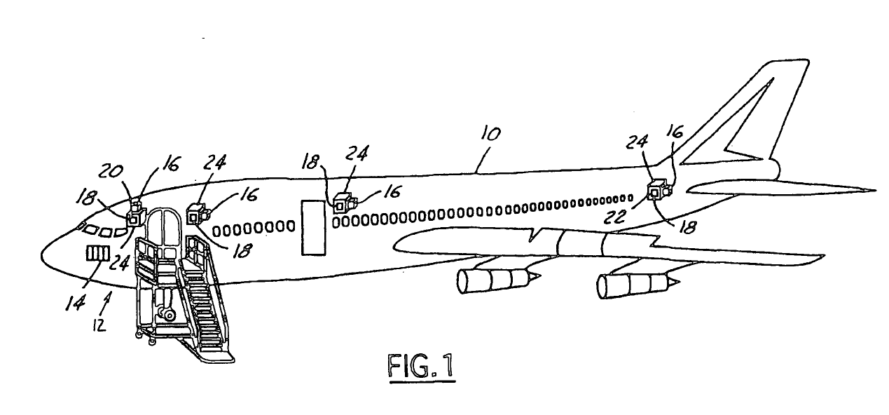

Referring now to FIG. 1, a perspective view of an aircraft 10 utilizing an air bag intrusion preventative deployment system 12 for delaying and preventing unwanted intrusions in accordance with an embodiment of the present invention is shown. The air bag deployment system 12 includes activation switches 14, generators 16, and air bags 18. Any number of switches 14, generators 16, and air bags 18 may be employed and each of which may be in various locations on the aircraft 10. In general, when an intruder is detected by a crewmember, the crewmember may activate one or more of the air bags 14 in any order to delay and prevent unwanted intrusion or access to a crewmember, a passenger, or to a restricted area within the aircraft 10. All of which is described in further detail below.

The switches 14 may be electrical, such as a solid-state switch or relay having contacts, or may be mechanical in nature. The switches 14 may be manually activated or controlled via a controller (not shown). Each of the switches 14 may trigger any number of the generators 16 sequentially, simultaneously, or in various orders. The switches 14 may be located in a close proximity to the air bags 18, such as air bag 20 or may be in a remote location, such as air bag 22.

The generators 16 may be of various type and style. The generators 16 when triggered may initiate a chemical reaction, as is commonly known in the art of ground-based vehicles, or may include a compressed cylinder or compressed air device, which is capable of providing a quick transfer of a pressurized volume of air between a holding device and an air bag. Although, it is preferred that gases produced as a result of a chemical reaction be stable, inert, nontoxic, and have properties such that they cool relatively quickly, the stated preferences may be modified for a given application. Of course, diffusers may be used to more quickly cool the produced gases. For example, production of argon gas may be preferred for a given application, since it has a quicker cooling time during expansion than that of nitrogen.

The generators 16 may include safety sensors and switches (not shown) to prevent accidental triggering of a generator 16 and deployment of an air bag 18. The generators 16 may also include other components, such as igniters, intensifiers, generants, filters, cooling devices, or other generator components known in the art. The generators 16 may be adjacent to and be part of a single module with the air bags 18, as shown, or may be separate from and located at a remote location from the air bags 18. Each of the generators 16 may deploy any number of the air bags 18.

The air bags 18 may be deployed to restrain, shock, fluster, repel, deter, immobilize or the like a target assailant for various lengths of time. The air bags 18 may be positioned at various heights or in various locations to perform as stated above and may also be positioned as to knock away or separate an unauthorized object, that may be used as a weapon, from the assailant, thereby, preventing undesired control and use of the weapon by the assailant.

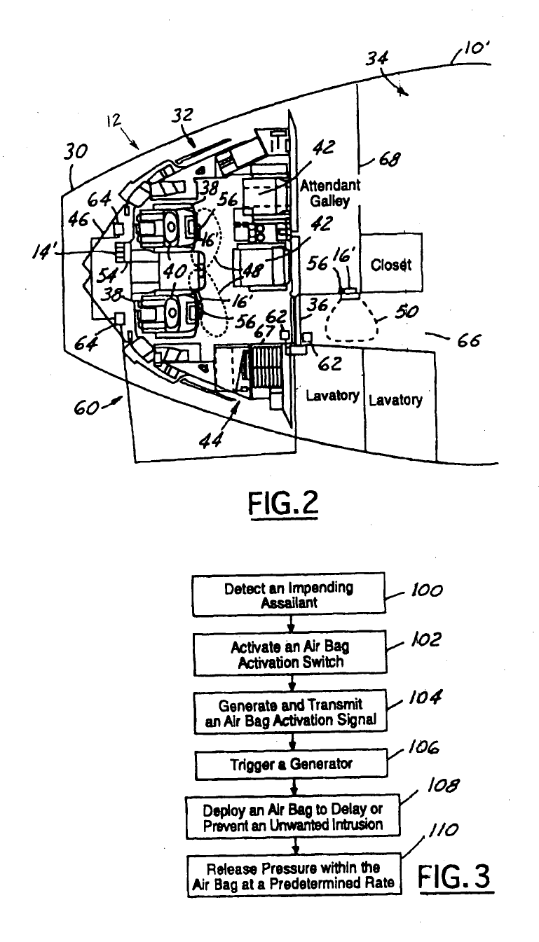

The air bags 18 may be of various size, type, and shape and take on various forms as they are deployed. The air bags 18 may exist or be housed within a wall, a floor, a ceiling, a seat, a panel, or in some other aircraft member, structure, holding device, or location known in the art. In the embodiment of FIG. 1 the air bags 18 are shown within housings 24. The air bags 18 may be deployed within various restricted areas including a flight compartment, a galley, a passenger compartment, an aisle way, a hallway, an exit door area, a baggage compartment, an electronic control area, a flight control area, or other restricted areas known in the art, some of which are illustrated in FIG. 2. The air bags 18 may also be deployed in areas other than restricted areas, for example, air bags may be deployed within a passenger compartment to delay and prevent access to a flight crewmember or passenger. The air bags 18 may be formed of commonly used ground-based airbag materials, such as nylon and neoprene, as well as other applicable materials known in the art.

In an embodiment of the present invention, the air bag housings 24 are designed, such that when the air bags 18 are in an inactive or undeployed state, the housings 24 do not intrude in aisle way space. The air bag housings 24, in one embodiment of the present invention, are designed, positioned, and located to contain and prevent interaction between the housings 24 and crewmembers or passengers. In another embodiment of the present invention, the air bag housings 24 are designed such that when there is interaction between the housings 24 and a crewmember or passenger an injury does not occur. For example, the air bag housings 24 may be padded or contoured such that interaction therewith does not result in an injury.

In an embodiment of the present invention, the air bags 18 are designed, such that after deployment, air pressure within the airbags 18 is released at a slow or reduced rate to further delay and prevent an unwanted intrusion, unlike that of ground-based vehicle in which pressure within an air bag is released quickly as to prevent the air bag from being restraining, interfering, or burdensome to a vehicle occupant. The air bags 18 may have relatively smaller air pressure release holes than are commonly used in ground-based vehicles to slow down post activation contraction rate of the air bags 18. The system 12 may employ some other contraction rate reduction device or technique known in the art, such as use of a control valve, to delay or prevent an unwanted intrusion.

Referring now to FIG. 2, a cross-sectional top view of a fore portion 30 of an aircraft 10′ in accordance with an embodiment of the present invention is shown. The aircraft 10′, as shown, has a flight deck compartment 32 and a passenger compartment 34, which are separated by a flight compartment door 36. The flight compartment 32 includes a pair of pilot seats 38 for pilots 40, a pair of observer seats 42, and a pilot galley area 44. The pilot galley area 44 may be in the form of a closet, as shown, or may include a crew rest area and other galley or facility devices. An air bag intrusion preventative deployment system 12′ is incorporated within the aircraft 10′ and is designed to delay and prevent access of an assailant to the pilots and to flight controls 46.

The air bag deployment system 12′ includes a set of activation switches 14′, a pair of pilot seat air bags 48, and a flight compartment door air bag 50. The air bags 48 and 50 have respective generators 16′. The activation switches 14′ are coupled to an activation switch transmitter 54, which may be a separate stand-alone transmitter, as shown, or may be incorporated into another or existing aircraft transmitter. For example, there typically are multiple aircraft transmitters that perform various functions, such as aircraft lighting, control of internal air pressures, and intercommunications. When one or more of the activation switches 14′ are in an activated state the transmitter 54 generates an appropriate activation signal, which is received by a corresponding receiver 56. The receiver 56 then triggers an associated generator 16′. In a further embodiment, the transmitter 54 and the receivers 56 are radio frequency (RF) based and each air bag has an assigned frequency or Internet Protocol (IP) address.

The system 12′ also includes an intruder monitoring system 60. The monitoring system 60 is used to monitor activity aft of the pilot seats 38. Intruder sensors 62 are capable of detecting an impending assailant and activity thereof, which is transferred in the form of an intruder signal to monitors 64 whereby the pilots 40 may observe activity of the assailant. The monitoring system 60 may be video or audio based.

Although, the air bags 48 and 50 are located in seats 38 and in isle way 66, the air bags 48 and 50 as well as other additional air bags (not shown) may be located in other areas of the flight compartment and the passenger compartment, as stated above, such as exterior to the pilot galley area 44 in wall 67 or in the attendant galley 68.

Referring now to FIG. 3, a method of delaying and preventing unwanted intrusions within an aircraft in accordance with an embodiment of the present invention is shown. The following steps of FIG. 3 are described with respect to configuration of the air bag deployment system 12′ of FIG. 2, for simplicity of description. The present invention and method of FIG. 3 is not intended to be limited to the configuration of FIG. 2 and may be modified for various other applications and configurations as stated above.

In step 100, an impending assailant is detected. The impending assailant may be detected simply via senses of a pilot or crewmember, through inter aircraft communications, or may be detected through use of the monitoring system 60. When the monitoring system 60 is used the intruder sensors 62 generate an intruder signal, which is indicated on the monitors 64.

In step 102, a crewmember such as one of the pilots 40 in response to detecting an assailant or in response to the intruder signal may activate one or more of the switches 14′ to delay and prevent access to the flight compartment 32 or people and devices contained therein.

In one embodiment of the present invention the switches 14′ are sequentially activated, such that the flight door air bag 50 is first activated as an assailant approaches or is attempting to enter the flight compartment 32. As the assailant proceeds past the air bag 50 and the flight compartment door 36 and enters the flight compartment the pair of air bags 48 are deployed. In so doing, providing multiple levels of time delay or an increased amount of time for the crewmembers to react to activity of the assailant and perform precautionary measures.

In step 104, the transmitter 54 generates and transmits an air bag activation signal in response to activation of the switches 14′. In step 106, one or more of the receivers 56 receive the air bag activation signal and trigger the appropriate generator 16′ to deploy one or more of the air bags 48 and 50. In step 108, one or more of the air bags 48 and 50 are deployed to delay and prevent an unwanted intrusion by the impending assailant. In one embodiment, the air bags 48 and 50 are deployed at a quick enough rate as to surprise and restrain an assailant but at a rate that minimizes harm to the assailant. In step 110, the system 12′ releases pressure in the deployed air bags 48 and 50 at a predetermined rate to further delay and prevent the unwanted intrusion.

The above-described steps are meant to be an illustrative example; the steps may be performed synchronously, sequentially, simultaneously, or in a different order depending upon the application.

The present invention provides an air bag deployment system for delaying and preventing access to crewmembers, passengers, and restricted areas of an aircraft, which increases safety and security thereof. The present invention is nonlethal and reversible. The present invention occupies minimal space and is lightweight. The present invention may be utilized in various areas of an aircraft and is capable of delaying and prevent an unwanted intrusion for varying levels of time.

The above-described apparatus and method, to one skilled in the art, is capable of being adapted for various applications and systems known in the art. The above-described invention can also be varied without deviating from the true scope of the invention.

What is claimed is:

1. An air bag intrusion preventative deployment system for delaying and preventing unwanted intrusions within an aircraft comprising:
at least one activation switch;
at least one generator coupled to said at least one activation switch; and
at least one air bag coupled to said at least one generator;
said activation switch when in an activated state triggers said at least one generator to deploy said at least one air bag to delay and prevent at least one unwanted intrusion.

2. A system as in claim 1 wherein deployment of said at least one air bag is performed to delay and prevent access to at least one of a flight crewmember, a passenger, and a restricted area of the aircraft.

3. A system as in claim 1 wherein said at least one air bag is deployed in a restricted area selected from at least one of a flight compartment, a galley, a passenger compartment, an isle way, a hallway, an exit door area, a baggage compartment, an electronic control area, and a flight control area.

4. A system as in claim 1 wherein said at least one switch is activated manually.

5. A system as in claim 1 wherein said at least one air bag is activated wirelessly.

6. A system as in claim 1 further comprising:
at least one transmitter electrically coupled to said at least one activation switch and generating an air bag activation signal when said at least one activation switch is in an activated state; and
at least one receiver electrically coupled to said at least one generator, receiving said air bag activation signal and activating said at least one generator.

7. A system as in claim 1 further comprising an intrusion monitoring system monitoring intruder activity.

8. A system as in claim 7 wherein said at least one switch is activated in response to said intruder activity.

9. A system as in claim 7 wherein said intrusion monitoring system comprises:
an intruder sensor detecting impending assailant activity and generating an intruder signal; and
an intruder monitor electrically coupled to said intruder sensor and indicating said impending assailant activity in response to said intruder signal.

10. A system as in claim 9 wherein said intruder monitor indicates video or audio signals.

11. A system as in claim 1 wherein said at least one air bag is sequentially activated.

12. A system as in claim 1 wherein said air bags are located in an aircraft member selected from at least one of a wall, a floor, a ceiling, a seat, and a panel.

13. A system as in claim 1 wherein said at least one air bag is deployed at a rate to at least temporarily restrain an impending assailant.

14. A system as in claim 1 wherein after deployment of said at least one air bag, the system releases pressure within said at least one air bag at a rate to further delay and prevent said at least one unwanted intrusion.

15. A system as in claim 1 wherein said at least one air bag comprises a pair of pilot seat air bags and a flight compartment door air bag.

16. A method of delaying and preventing unwanted intrusions within an aircraft comprising:
detecting an impending assailant;
activating at least one air bag switch in response to detection of said impending assailant; and
deploying said at least one air bag to delay and prevent an unwanted intrusion by said impending assailant.

17. A method as in claim 16 further comprising releasing pressure in said at least one air bag at a predetermined rate to delay and prevent said at least one unwanted intrusion.

18. A method as in claim 16 further comprising:
generating and transmitting an air bag activation signal when said at least one activation switch is in an activated state; and
receiving said air bag activation signal and activating at least one generator to deploy said at least one air bag.

19. A method as in claim 16 wherein detecting an impending assailant comprises:
generating an intruder signal; and
indicating impending assailant activity in response to said intruder signal.

20. An air bag intrusion preventative deployment system for delaying and preventing unwanted intrusions within an aircraft comprising:
a pair of activation switches positioned in close proximity to a crewmember;
a pair of generators coupled to said pair of switches;
a pair of pilot seat air bags coupled to a first generator of said pair of generators; and
a flight compartment door air bag coupled to a second generator of said pair of generators;
said pair of activation switches when manually activated causing said pair of generators to deploy, respectively, said pair of pilot seat air bags and said flight compartment door air bag to delay and prevent access to at least one restricted area of the aircraft.
